(19) United States
(12) Patent Application Publication
(10) Pub. No.: US 2014/0125806 A1
(43) Pub. Date: May 8, 2014

(54) Sports Apparatus and Method

(71) Applicant: Sstatzz Oy, Helsinki (FI)

(72) Inventors: Teemu Kemppainen, Espoo (FI); Harri Hohteri, Helsinki (FI)

(73) Assignee: Sstatzz Oy, Helsinki (FI)

(21) Appl. No.: 14/149,991

(22) Filed: Jan. 8, 2014

Related U.S. Application Data
(63) Continuation-in-part of application No. 13/471,404, filed on May 14, 2012.
Application No. 13/471,404 is a continuation-in-part of application No. 13/660,247, filed on Oct. 25, 2012.

(51) Int. Cl. H04N 7/18

(52) U.S. Cl. CPC H04N 7/183
USPC 348/157

(57) ABSTRACT

A sports apparatus for monitoring spatial positions of players within a spatial playing region is provided. The sports apparatus includes personal monitors carried by the players, and a monitoring arrangement coupled in communication with the personal monitors for determining spatial positions of the personal monitors within the spatial playing region. The sports apparatus also includes a camera arrangement for capturing views of at least a portion of the spatial playing region for determining spatial positions of the players within the spatial playing region, and a data merging arrangement for merging position-measurement data generated by the monitoring arrangement and the camera arrangement to provide output information indicative of the spatial positions of the players within the spatial playing region.

### TECHNICAL FIELD

The present disclosure relates generally to player tracking; and more specifically, to sports apparatus for monitoring spatial positions of players within a spatial playing region. Moreover, the present disclosure relates to methods of employing sports apparatus for monitoring spatial positions of players within a spatial playing region. Furthermore, the present disclosure also relates to software products recorded on non-transient machine-readable data storage media, wherein the software products are executable upon computing hardware of the aforesaid sports apparatus to implement the aforesaid methods.

### BACKGROUND

In past few decades, player tracking has emerged as an area of interest. From a training or statistical analysis point of view, it is desirable to obtain detailed information about how players and/or a ball are moving during a game. Moreover, sports viewers are often interested in information about their favourite players, while viewing a live-telecast of the game.

Conventionally, various techniques have been employed to track players when they move within a spatial playing region. Some conventional techniques for tracking players use triangulation or trilateration to determine spatial positions of the players carrying wireless-enabled objects within the spatial playing region. These techniques identify the players accurately. However, they provide spatially inaccurate data, as their results often involve an error of a few meters.

Other convention techniques for tracking players employ multiple cameras for video detection of spatial positions of the players. These techniques determine the spatial positions of the players fairly accurately. However, these conventional techniques suffer from several disadvantages. Firstly, these techniques are unable to identify the players reliably at all times, as they use a global detector, such as a Histogram of Oriented Gradients (HOG) detector for identifying individual players. Secondly, these techniques are not fast enough to be able to cope with demands of identifying the players in a fast-paced team sport, where the players look very similar to each other. Thirdly, these techniques are complex and expensive.

Therefore, there exists a need for a sports apparatus for monitoring accurate spatial positions of players within a spatial playing region in real-time.

### SUMMARY

The present disclosure seeks to provide an improved sports apparatus for monitoring one or more spatial positions of one or more players within a spatial playing region.

The present disclosure also seeks to provide an improved method of employing a sports apparatus for monitoring one or more spatial positions of one or more players within a spatial playing region.

In one aspect, embodiments of the present disclosure provide a sports apparatus for monitoring one or more spatial positions of one or more players within a spatial playing region. The sports apparatus includes one or more personal monitors, a monitoring arrangement, a camera arrangement and a data merging arrangement.

The personal monitors are carried by the players, when the players move within the spatial playing region. The monitoring arrangement is coupled in communication with the personal monitors for determining one or more spatial positions of the personal monitors within the spatial playing region.

Beneficially, the monitoring arrangement is operable to employ wireless communication for sending and/or receiving signals to and/or from the personal monitors. Additionally, the monitoring arrangement is operable to employ, for position measurement within the spatial playing region, at least one of: triangulation measurement, trilateration measurement, Time-of-Flight (ToF) measurement, Received Signal Strength Indicator (RSSI) measurement, and/or Global Positioning System (GPS) measurement.

Moreover, the camera arrangement is operable to capture views of at least a portion of the spatial playing region for determining spatial positions of the players when moving within the spatial playing region. For this purpose, the camera arrangement is optionally operable to employ at least one of: one or more Pan-Tilt-Zoom (PTZ) cameras following movement of the players, and/or one or more stationary cameras imaging substantially a whole of the spatial playing region.

Moreover, the data merging arrangement is operable to merge position-measurement data generated by the monitoring arrangement and the camera arrangement to provide output information indicative of the spatial positions of the players within the spatial playing region. For this purpose, the data merging arrangement is optionally operable to employ at least one particle filter.

Moreover, the data merging arrangement is optionally operable to employ a model for the players based upon one or more probabilities of the players being within one or more corresponding spatial zones of the spatial playing region at any given time. These spatial zones are optionally moved within the model corresponding to one or more rates and/or one or more directions of spatial movements of the players within the spatial playing region.

Furthermore, the monitoring arrangement in combination with the personal monitors is optionally operable to enable the data merging arrangement to identify the spatial positions of the personal monitors and corresponding unique identities of the personal monitors. These corresponding unique identities identify the players carrying the personal monitors. On the other hand, the camera arrangement is optionally operable to enable the data merging arrangement to identify the spatial positions of the players but not their corresponding unique identities.

The monitoring arrangement provides less accurate measurements of the spatial positions, relative to the camera arrangement. However, the monitoring arrangement identifies the players more accurately, relative to the camera arrangement. Therefore, the output information, obtained by merging the position-measurement data generated by the monitoring arrangement and the camera arrangement, provides accurate spatial positions of the players within the spatial playing region.

Beneficially, the data merging arrangement is optionally arranged to operate in substantially real-time, and to receive the position-measurement data generated by the monitoring arrangement and the camera arrangement in substantially real-time. Consequently, the sports apparatus is optionally operable to function in substantially real-time, with a measurement-update rate of at least 10 samples per second.

Beneficially, the sports apparatus can be arranged to be used in association with at least one of: a basketball pitch, a handball pitch, a football pitch, an American football pitch, a hockey pitch, an ice hockey pitch, a tennis pitch, a cricket pitch, a cricket field, a volleyball pitch, a baseball field, a polo field, and/or a golf course.

In another aspect, embodiments of the present disclosure provide a method of employing the sports apparatus for monitoring the spatial positions of the players within the spatial playing region.

In yet another aspect, embodiments of the present disclosure provide a software product recorded on non-transient machine-readable data storage media, wherein the software product is executable upon computing hardware of the sports apparatus for implementing the aforementioned method.

Embodiments of the present disclosure substantially eliminate, or at least partially address, the aforementioned problems in the prior art, and enable merging of position-measurement data originating from heterogeneous sources to provide accurate spatial positions of players within a spatial playing region in substantially real-time.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a schematic illustration of an example playing scenario in which a sports apparatus is implemented pursuant to the present disclosure;

FIG. 2 is a schematic illustration of the sports apparatus, in accordance with an embodiment of the present disclosure;

FIG. 3 is a schematic illustration of various components in an example implementation of a personal monitor, in accordance with an embodiment of the present disclosure;

FIG. 4 is an illustration of an example of position measurements collected sparsely on a spatial playing region, in accordance with an embodiment of the present disclosure;

FIGS. 5A, 5B, 5C and 5D are illustrations of an example implementation of a particle filter employed by a data merging arrangement, in accordance with an embodiment of the present disclosure; and

FIG. 6 is an illustration of steps of a method of employing the sports apparatus for monitoring one or more spatial positions of one or more players within a spatial playing region, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although the best mode of carrying out the present disclosure has been disclosed, those skilled in the art would recognize that other embodiments for carrying out or practicing the present disclosure are also possible.

Embodiments of the present disclosure provide a sports apparatus for monitoring one or more spatial positions of one or more players within a spatial playing region. The sports apparatus includes one or more personal monitors, a monitoring arrangement, a camera arrangement and a data merging arrangement.

The personal monitors are carried by the players, when the players move within the spatial playing region. The monitoring arrangement is coupled in communication with the personal monitors for determining one or more spatial positions of the personal monitors within the spatial playing region.

Beneficially, the monitoring arrangement is operable to employ wireless communication for sending and/or receiving signals to and/or from the personal monitors. Additionally, the monitoring arrangement is operable to employ, for position measurement within the spatial playing region, at least one of: triangulation measurement, trilateration measurement, Time-of-Flight (ToF) measurement, Received Signal Strength Indicator (RSSI) measurement, and/or Global Positioning System (GPS) measurement.

Moreover, the camera arrangement is operable to capture views of at least a portion of the spatial playing region for determining spatial positions of the players when moving within the spatial playing region. For this purpose, the camera arrangement is optionally operable to employ at least one of: one or more Pan-Tilt-Zoom (PTZ) cameras following movement of the players, and/or one or more stationary cameras imaging substantially a whole of the spatial playing region, and/or one or more cameras which can be moved (carried by camera men/moving equipment).

Moreover, the data merging arrangement is operable to merge position-measurement data generated by the monitoring arrangement and the camera arrangement to provide output information indicative of the spatial positions of the players within the spatial playing region. For this purpose, the data merging arrangement is optionally operable to employ at least one particle filter.

Moreover, the data merging arrangement is optionally operable to employ a model for the players based upon one or more probabilities of the players being within one or more corresponding spatial zones of the spatial playing region at any given time. These spatial zones are optionally moved or expanded or contracted within the model corresponding to one or more rates and/or one or more directions of spatial movements of the players within the spatial playing region.

Additionally, separate probabilities and/or spatial zones are optionally computed with respect to the position-measurement data generated by the monitoring arrangement and the camera arrangement. Accordingly, the monitoring arrangement in combination with the personal monitors is optionally operable to enable the data merging arrangement to identify the spatial positions of the personal monitors and corresponding unique identities of the personal monitors. These corresponding unique identities identify the players carrying the personal monitors. On the other hand, the camera arrangement is optionally operable to enable the data merging arrangement to identify the spatial positions of the players but not their corresponding unique identities.

The monitoring arrangement provides less accurate measurements of the spatial positions, relative to the camera arrangement. However, the monitoring arrangement identifies the players more accurately, relative to the camera arrangement. Therefore, the output information, obtained by merging the position-measurement data generated by the monitoring arrangement and the camera arrangement, provides accurate spatial positions of the players within the spatial playing region.

Beneficially, the data merging arrangement is optionally arranged to operate in substantially real-time, and to receive the position-measurement data generated by the monitoring arrangement and the camera arrangement in substantially real-time. Consequently, the sports apparatus is optionally operable to function in substantially real-time, with a measurement-update rate of at least 10 samples per second.

Furthermore, embodiments of the present disclosure are suitable for sports such as basketball, handball, football, American football, hockey, ice hockey, tennis, cricket, volleyball, baseball, polo, and golf, but not limited thereto. Beneficially, the sports apparatus can be arranged to be used in association with at least one of: a basketball pitch, a handball pitch, a football pitch, an American football pitch, a hockey pitch, an ice hockey pitch, a tennis pitch, a cricket pitch, a cricket field, a volleyball pitch, a baseball field, a polo field, and/or a golf course.

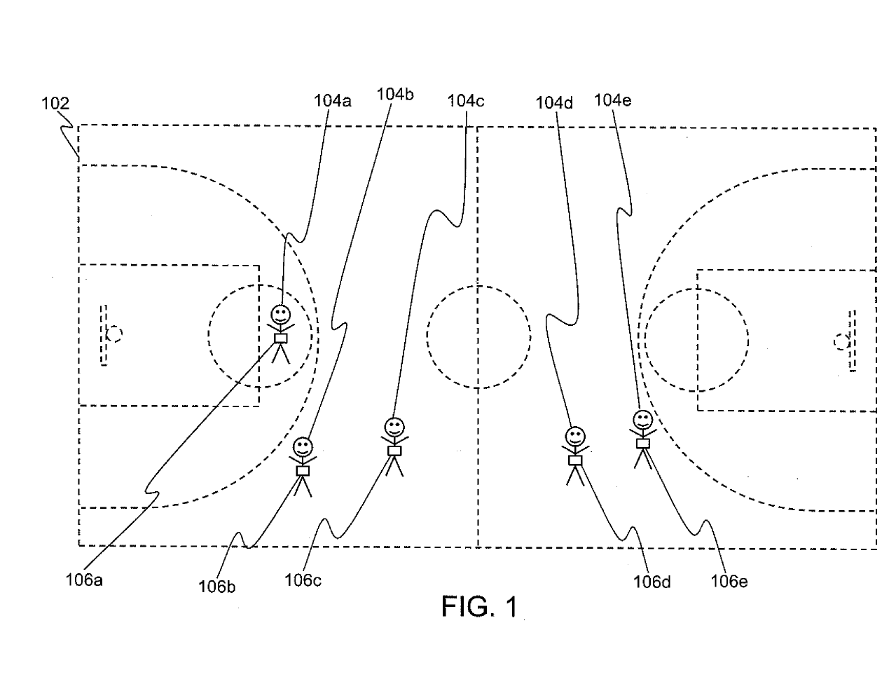

Referring now to the drawings, particularly by their reference numbers, FIG. 1 is a schematic illustration of an example playing scenario in which a sports apparatus is implemented pursuant to the present disclosure. In FIG. 1, there is shown a spatial playing region 102, and one or more players, depicted as a player 104a, a player 104b, a player 104c, a player 104d and a player 104e (hereinafter collectively referred to as players 104).

The players 104 play a game or perform practice in the spatial playing region 102. In the example playing scenario, the spatial playing region 102 is a basketball pitch. It is to be noted here that the spatial playing region 102 can alternatively be any of: a handball pitch, a football pitch, an American football pitch, a hockey pitch, an ice hockey pitch, a tennis pitch, a cricket pitch, a cricket field, a volleyball pitch, a baseball field, a polo field, or a golf course.

The sports apparatus includes one or more personal monitors, depicted as a personal monitor 106a, a personal monitor 106b, a personal monitor 106c, a personal monitor 106d and a personal monitor 106e (hereinafter collectively referred to as personal monitors 106). The players 104 carry their corresponding personal monitors 106, for example, by wearing the personal monitors 106, when they move within the spatial playing region 102. With reference to FIG. 1, the players 104a, 104b, 104c, 104d, 104e are carrying the personal monitors 106a, 106b, 106c, 106d, 106e respectively. The players 104 may, for example, wear the personal monitors 106 by a detachable attachment to waist, wrist, ankle, or any other suitable part of their bodies.

In an example, the sports apparatus may be implemented for use in a game of ice hockey, wherein the spatial playing region 102 may be an ice hockey pitch. Accordingly, the players 104 may be carrying and/or wearing one or more sports equipments, such as a hockey stick, hockey skates, a hockey helmet, protective gloves and various protective pads, during playing of the game. Beneficially, the personal monitors 106 may be implemented spatially within at least one of the sports equipments carried and/or worn by the players 104.

Moreover, the sports apparatus includes a monitoring arrangement (not shown in FIG. 1) coupled in communication with the personal monitors 106. The monitoring arrangement is operable to determine one or more spatial positions of the personal monitors 106 within the spatial playing region 102.

Moreover, the sports apparatus also includes a camera arrangement (not shown in FIG. 1) for capturing views of at least a portion of the spatial playing region 102 for determining spatial positions of the players 104 when they move within the spatial playing region 102.

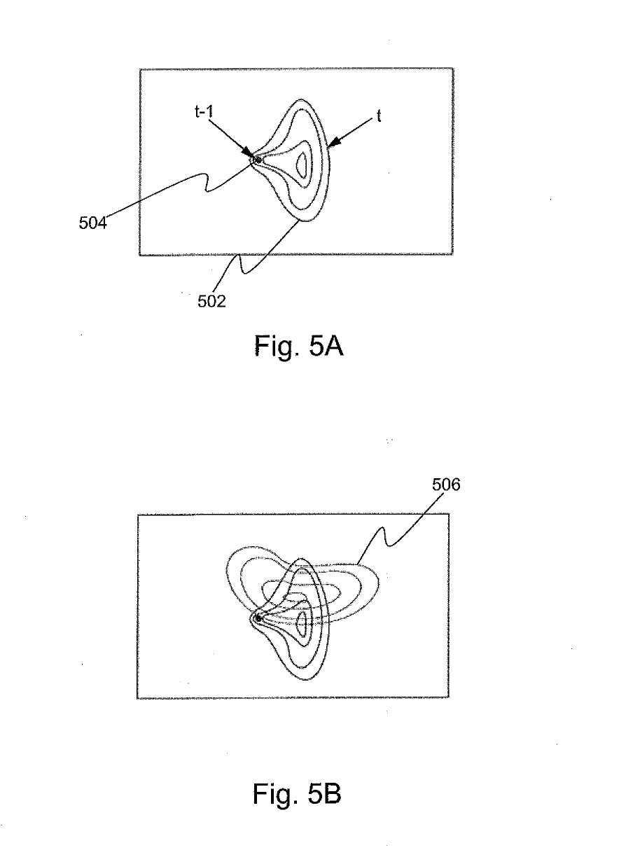

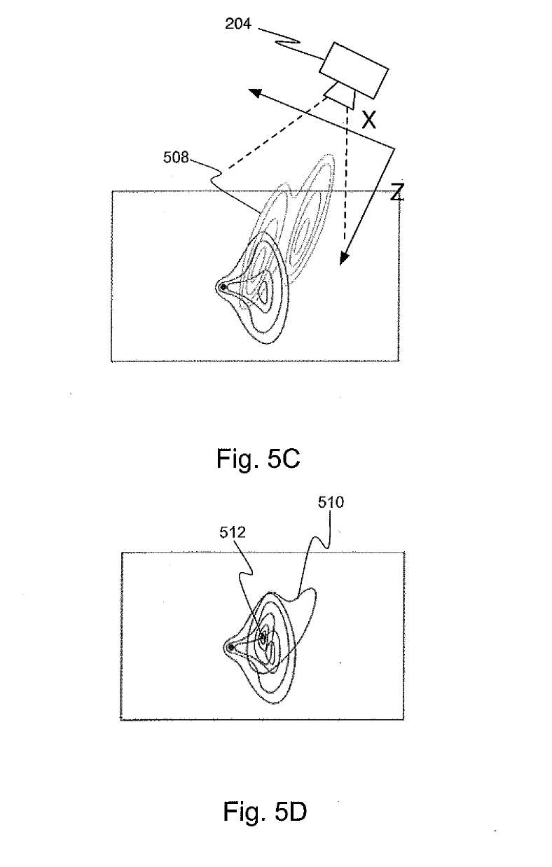

Furthermore, the sports apparatus also includes a data merging arrangement (not shown in FIG. 1) for merging position-measurement data generated by the monitoring arrangement and the camera arrangement to provide output information indicative of accurate spatial positions of the players 104 within the spatial playing region 102. For this purpose, the data merging arrangement is optionally operable to employ at least one particle filter. Implementation details of an example particle filter have been provided in conjunction with FIGS. 5A, 5B, 5C and 5D.

Moreover, the monitoring arrangement in combination with the personal monitors 106 is optionally operable to enable the data merging arrangement to identify the spatial positions of the personal monitors 106 and corresponding unique identities of the personal monitors 106. These corresponding unique identities identify the players 104 carrying the personal monitors 106. On the other hand, the camera arrangement is optionally operable to enable the data merging arrangement to identify the spatial positions of the players 104 but not their corresponding unique identities.

The monitoring arrangement provides less accurate measurements of the spatial positions, relative to the camera arrangement. However, the monitoring arrangement identifies the players 104 more accurately, relative to the camera arrangement. Therefore, the output information, obtained by merging the position-measurement data generated by the monitoring arrangement and the camera arrangement, provides accurate spatial positions of the players 104 within the spatial playing region 102.

Beneficially, the data merging arrangement is optionally arranged to operate in substantially real-time, and to receive the position-measurement data generated by the monitoring arrangement and the camera arrangement in substantially real-time.

FIG. 1 is merely an example, which should not unduly limit the scope of the claims herein. It is to be understood that the implementation of the sports apparatus is provided as an example and is not limited to a specific number of players and personal monitors. A person skilled in the art will recognize many variations, alternatives, and modifications of embodiments of the present disclosure.

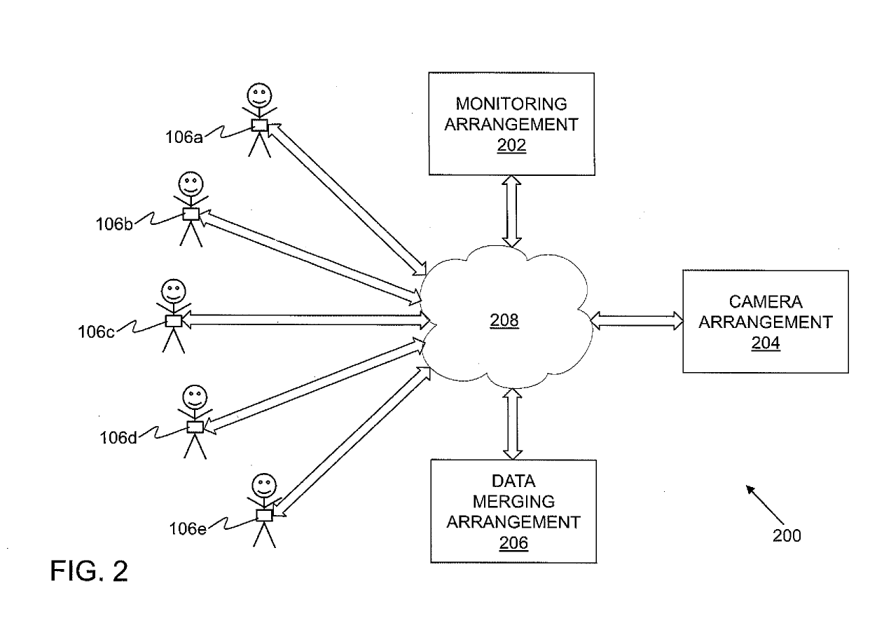

FIG. 2 is a schematic illustration of a sports apparatus 200, in accordance with an embodiment of the present disclosure. For illustration purposes only, the sports apparatus 200 has been implemented in the spatial playing region 102. The sports apparatus 200 includes the personal monitors 106, a monitoring arrangement 202, a camera arrangement 204, and a data merging arrangement 206.

The monitoring arrangement 202 is coupled in communication with the personal monitors 106, via a communication network 208. Moreover, the monitoring arrangement 202 and the camera arrangement 204 communicate their respective position-measurement data to the data merging arrangement 206, via the communication network 208.

The communication network 208 can be a collection of individual networks, interconnected with each other and functioning as a single large network. Such individual networks may be wired, wireless, or a combination thereof. Examples of such individual networks include, but are not limited to, Local Area Networks (LANs), Wide Area Networks (WANs), Metropolitan Area Networks (MANs), Wireless LANs (WLANs), Wireless WANs (WWANs), Wireless MANs (WMANs), the Internet, second generation (2G) telecommunication networks, third generation (3G) telecommunication networks, fourth generation (4G) telecommunication networks, and Worldwide Interoperability for Microwave Access (WiMAX) networks.

Additionally or alternatively, the personal monitors 106 and the monitoring arrangement 202 may use their own “Bluetooth” network. (“Bluetooth” is a registered trademark).

In order to determine spatial positions of the personal monitors 106, the monitoring arrangement 202 is beneficially operable to employ wireless communication for sending and/or receiving signals to and/or from the personal monitors 106. Additionally, the monitoring arrangement 202 is optionally operable to employ, for position measurement within the spatial playing region 102, at least one of: triangulation measurement, trilateration measurement, Time-of-Flight (ToF) measurement, Received Signal Strength Indicator (RSSI) measurement, and/or Global Positioning System (GPS) measurement.

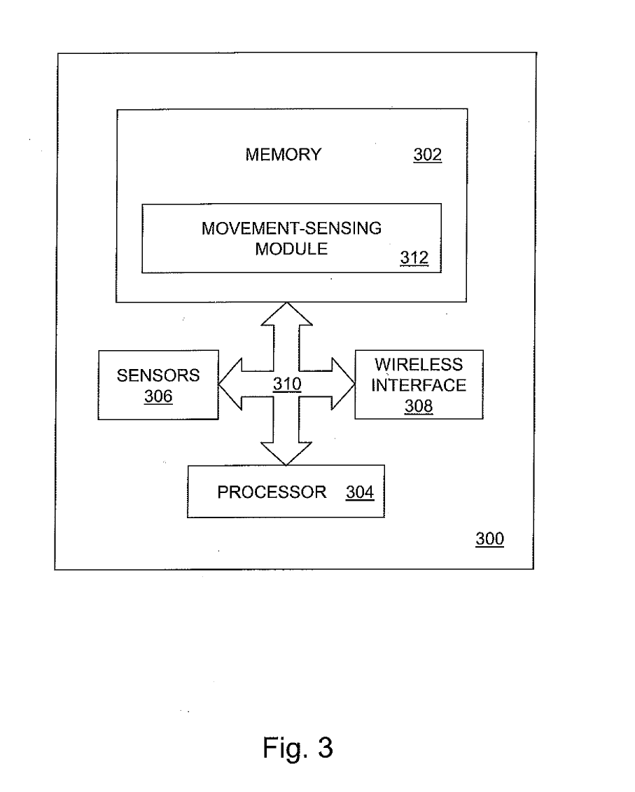

Additionally, each of the personal monitors 106 optionally includes a movement-sensing arrangement that is operable to generate movement data indicative of accelerations and/or rotations and/or orientations of that personal monitor. Details of the movement-sensing arrangement have been provided in conjunction with FIG. 3.

In an example, movement data corresponding to a particular personal monitor includes at least one of: a unique identity associated with that particular personal monitor, information pertaining to one or more movements (for example, accelerations and/or rotations and/or orientations) of that particular personal monitor, one or more spatial positions of that particular personal monitor, and/or associated time stamps.

Beneficially, the personal monitors 106 are optionally operable to communicate their corresponding movement data to the monitoring arrangement 202 via wireless communication links. Such wireless communication links may be either uni-directional or bi-directional.

Additionally, the personal monitors 106 may communicate their corresponding movement data to the monitoring arrangement 202 in a round-robin manner.

Subsequently, the monitoring arrangement 202 is optionally operable to use classical mechanics to analyze the movement data, and to integrate the movement data with the spatial positions of the personal monitors 106 to generate position-measurement data corresponding to the personal monitors 106.

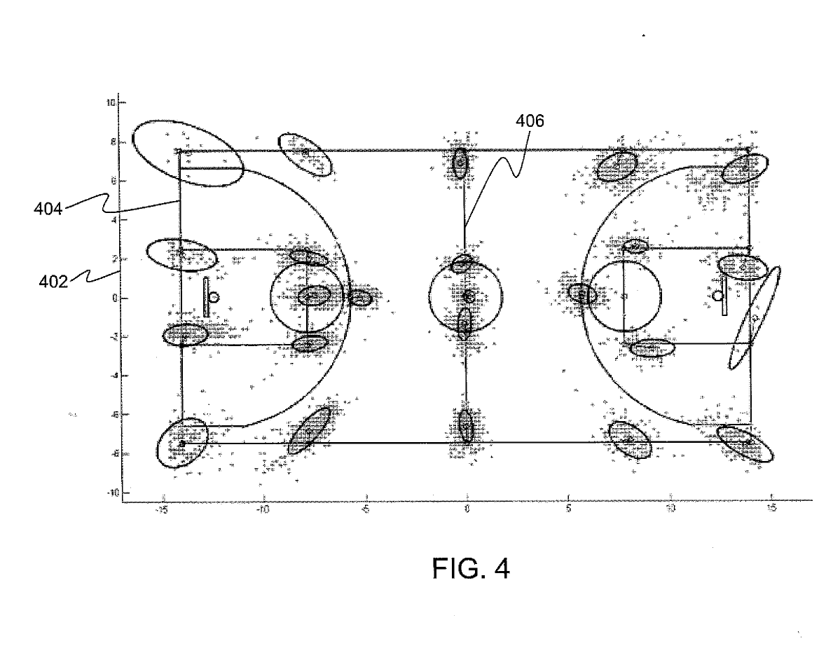

Moreover, the monitoring arrangement 202 is optionally operable to calibrate the position-measurement data on the spatial playing region 102. Details of how the position-measurement data may be calibrated have been provided in conjunction with FIG. 4.

Moreover, the camera arrangement 204 is operable to capture views of at least a portion of the spatial playing region 102 for determining spatial positions of the players 104 when the players 104 move within the spatial playing region 102. For this purpose, the camera arrangement 204 is optionally operable to employ at least one of: one or more Pan-Tilt-Zoom (PTZ) cameras following movement of the players 104, and/or one or more stationary cameras imaging substantially a whole of the spatial playing region 102.

Beneficially, the camera arrangement 204 is optionally operable to calibrate one or more cameras employed by the camera arrangement 204. For this purpose, the camera arrangement 204 is optionally operable to project objects in the spatial playing region 102 onto a coordinate system of video frames captured by these cameras. These objects may, for example, include line crossings and corners on the spatial playing region 102 and/or the players 104 moving within the spatial playing region 102.

Accordingly, the camera arrangement 204 is optionally operable to compute parameters, such as camera pose, corresponding to the cameras. For this purpose, the camera arrangement 204 is optionally operable to use computer vision to detect the spatial playing region 102, namely, its boundaries, the line crossings and/or the corners. Additionally or alternatively, the camera arrangement 204 is optionally operable to employ inertial navigation using sensors, such as accelerometer and gyroscopic sensor, within these cameras to detect their corresponding camera poses.

For stationary cameras, these parameters may be computed only once. For moving cameras, the parameters may be computed repeatedly, for example, when these cameras pan, tilt, zoom or move.

In some examples, a single camera with a substantially wide angle view may be employed to capture aerial views of substantially the whole of the spatial playing region 102. Beneficially, such aerial views potentially prevent player occlusion, and enable a substantially complete and accurate calibration of the camera.

As a result of the calibration, the camera arrangement 204 is optionally operable to convert position measurements within the video frames into position measurements within the spatial playing region 102. Consequently, the camera arrangement 204 is operable to generate position-measurement data corresponding to the players 104.

Furthermore, the data merging arrangement 206 is operable to merge the position-measurement data generated by the monitoring arrangement 202 and the camera arrangement 204 to provide output information indicative of accurate spatial positions of the players 104 within the spatial playing region 102. For this purpose, the data merging arrangement 206 is optionally operable to employ at least one particle filter. Implementation details of an example particle filter have been provided in conjunction with FIGS. 5A, 5B, 5C and 5D.

Additionally, the data merging arrangement 206 is optionally operable to take into account other sensor data including, for example, a status of a clock and/or a position of a ball during playing of the game.

Beneficially, the data merging arrangement 206 is optionally operable to employ a model for the players 104 based upon one or more probabilities of the players 104 being within one or more corresponding spatial zones of the spatial playing region 102 at any given time. These probabilities correspond to pre-defined state variables of the players 104. These pre-defined state variables optionally include spatial positions of the players 104 and/or rates at which the players 104 spatially move within the spatial playing region 102. The pre-defined state variables may be either user-defined or system-defined by default.

The model assumes that the players 104 exhibit Markov property. This means that a current state of a particular player is a function of an immediately-previous state and current measurements. Accordingly, the data merging arrangement 206 is optionally operable to take into account at least one of:

(a) the aforementioned movement data of the personal monitors 106 carried by the players 104 generated at a current time ‘t’,
(b) spatial positions of the players 104 at a previous time ‘t−1’, and/or
(c) a priori knowledge of individual roles of the player 104, for example, such as point guard, shooting guard, small forward, power forward and centre, in a game of basketball.

These spatial zones are optionally moved or expanded or contracted within the model corresponding to one or more rates and/or one or more directions of spatial movements of the players 104 within the spatial playing region 102. The rates and/or the directions are optionally computed from the aforementioned movement data by using classical mechanics.

Additionally, separate probabilities and/or spatial zones are optionally computed with respect to the position-measurement data generated by the monitoring arrangement 202 and the camera arrangement 204. Optionally, these probabilities can be approximated to identify the spatial zones within which the players 104 are most likely to be found.

Accordingly, the monitoring arrangement 202 in combination with the personal monitors 106 is optionally operable to enable the data merging arrangement 206 to identify the spatial positions of the personal monitors 106 and corresponding unique identities of the personal monitors 106. These corresponding unique identities identify the players 104 carrying the personal monitors 106. On the other hand, the camera arrangement 204 is optionally operable to enable the data merging arrangement 206 to identify the spatial positions of the players 104 but not their corresponding unique identities.

The monitoring arrangement 202 provides less accurate measurements of the spatial positions, relative to the camera arrangement 204. However, the monitoring arrangement 202 identifies the players 104 more accurately, relative to the camera arrangement 204. Therefore, the output information, obtained by merging the position-measurement data generated by the monitoring arrangement 202 and the camera arrangement 204, provides accurate spatial positions of the players 104 within the spatial playing region 102. Details of how the output information can be obtained have been provided in conjunction with FIGS. 5A, 5B, 5C and 5D.

Furthermore, the output information so obtained may then be used for various purposes, for example, including mapping position coordinates of the players 104 to the coordinate system of the video frames captured by the camera arrangement 204, and visualizing as graphics on top of the video frames. The video frames along with the visualized graphics may then be streamed to devices of sports viewers and/or coaches substantially in real-time. Examples of such devices include, but are not limited to, mobile phones, smart telephones, Mobile Internet Devices (MIDs), tablet computers, Ultra-Mobile Personal Computers (UMPCs), phablet computers, Personal Digital Assistants (PDAs), web pads, Personal Computers (PCs), handheld PCs, laptop computers, desktop computers, large-sized touch screens with embedded PCs, and interactive entertainment devices, such as game consoles, video players, Television (TV) sets and Set-Top Boxes (STBs).

Beneficially, the data merging arrangement 206 is optionally arranged to operate in substantially real-time, and to receive the position-measurement data generated by the monitoring arrangement 202 and the camera arrangement 204 in substantially real-time. Consequently, the sports apparatus 200 is optionally operable to function in substantially real-time, with a measurement-update rate of at least 10 samples per second.

Alternatively, the data merging arrangement 206 may be arranged to operate periodically or randomly.

In some examples, the sports apparatus 200 may include one or more databases (not shown in FIG. 2), whereat the data merging arrangement 206 may store the output information indicative of accurate spatial positions of the players 104 within the spatial playing region 102.

In some examples, the data merging arrangement 206 may be coupled in communication with a remote server (not shown in FIG. 2) that may be operable to collect statistical data indicative of movements and/or spatial positions of the players 104 as a function of time. The remote server may, for example, be operable to further analyze the statistical data to provide feedback on the performance of the players 104.

Beneficially, the data merging arrangement 206 may be implemented using a computing device that includes computing hardware, which is operable to execute one or more software products recorded on non-transient machine-readable data storage media. Typical examples of the computing device include, but are not limited to, a mobile phone, a smart telephone, an MID, a tablet computer, a UMPC, a phablet computer, a PDA, a web pad, a PC, a handheld PC, a laptop computer, a desktop computer, a large-sized touch screen with an embedded PC, and a server.

Furthermore, the sports apparatus 200 is suitable for implementation in sports such as basketball, handball, football, American football, hockey, ice hockey, tennis, cricket, volleyball, baseball, polo, and golf, but not limited thereto. Beneficially, the sports apparatus 200 can be arranged to be used in association with at least one of: a basketball pitch, a handball pitch, a football pitch, an American football pitch, a hockey pitch, an ice hockey pitch, a tennis pitch, a cricket pitch, a cricket field, a volleyball pitch, a baseball field, a polo field, and/or a golf course.

It should be noted here that the sports apparatus 200 is not limited to a specific number of personal monitors, monitoring arrangements, cameras, camera arrangements, and data merging arrangements. FIG. 2 is merely an example, which should not unduly limit the scope of the claims herein. A person skilled in the art will recognize many variations, alternatives, and modifications of embodiments of the present disclosure. For example, the sports apparatus 200 can be implemented for monitoring objects and/or people in other environments, such as a super market, a stadium, and so on.

FIG. 3 is a schematic illustration of various components in an example implementation of a personal monitor 300, in accordance with an embodiment of the present disclosure. The personal monitor 300 could be implemented as the personal monitors 106. The personal monitor 300 includes, but is not limited to, a data memory 302, a processor 304, a configuration of sensors 306, a wireless interface 308, and a system bus 310 that operatively couples various components including the data memory 302, the processor 304, the sensors 306 and the wireless interface 308. The data memory 302 optionally stores a movement-sensing module 312.

The personal monitor 300 also includes a power source (not shown in FIG. 3) for supplying electrical power to various components of the personal monitor 300. The power source may, for example, be a battery or other suitable power storage means.

The sensors 306 optionally include at least one of: accelerometer, magnetometer, pressure sensor, temperature sensor, gyroscopic sensor, GPS receiver, proximity sensor, Bluetooth beacon, or timer. Outputs generated by the sensors 306 may, for example, be indicative of accelerations and/or rotations and/or orientations of the personal monitor 300 as a function of time.

Beneficially, the movement-sensing module 312 is optionally interfaced with the sensors 306. The sensors 306 and the movement-sensing module 312 form a part of a movement-sensing arrangement of the personal monitor 300.

When executed on the processor 304, the movement-sensing module 312 is operable to resolve and integrate the outputs generated by the sensors 306 into movement data corresponding to the personal monitor 300.

As described earlier, the movement data may include at least one of: a unique identity associated with the personal monitor 300, information pertaining to one or more movements (for example, accelerations and/or rotations and/or orientations) of the personal monitor 300, one or more spatial positions of the personal monitor 300, and/or associated time stamps. The unique identity may, for example, be a Media Access Control (MAC) address, a Terminal Identifier (TID), or other identification pertaining to the personal monitor 300.

The sensors 306 optionally include a GPS receiver for determining one or more absolute spatial positions of the personal monitor 300 upon a surface of the Earth.

The sensors 306 optionally include a proximity sensor for sensing presence of other personal monitors in a proximity of the personal monitor 300. Consequently, the proximity sensor detects presence of other players carrying the other personal monitors in the proximity of a player carrying the personal monitor 300.

The sensors 306 optionally include a timer for including the time stamps in the movement data. Alternatively, the processor 304 may provide system time as reference for including the time stamps in the movement data.

Moreover, the personal monitor 300 is optionally operable to communicate the movement data to the monitoring arrangement 202 using the wireless interface 308. As described earlier, the monitoring arrangement 202 is optionally operable to analyze the movement data, and to integrate the movement data with spatial positions of the personal monitor 300 to generate position-measurement data corresponding to the personal monitor 300.

Optionally, the wireless interface 308 may be used to upload new configuration and/or software updates to the personal monitor 300, as and when required.

FIG. 3 is merely an example, which should not unduly limit the scope of the claims herein. It is to be understood that the specific designation for the personal monitor 300 is provided as an example and is not to be construed as limiting the personal monitor 300 to specific numbers, types, or arrangements of modules and/or components of the personal monitor 300. A person skilled in the art will recognize many variations, alternatives, and modifications of embodiments of the present disclosure. For example, a personal monitor similar to the personal monitor 300 may be embedded within a ball with which the players 104 play a game. Accordingly, sensor data from the personal monitor may be used to identify which player held the ball at any given time.

Furthermore, in order to calibrate the position-measurement data, the monitoring arrangement 202 is optionally operable to collect position measurements from known points within the spatial playing region 102 over a period of time. Subsequently, the monitoring arrangement 202 is optionally operable to compute and analyze statistics of the collected position measurements to correct measurement-biased errors. Such measurement-biased errors may result from reflections of signals, for example, from nearby walls or other objects.

The position-measurement data so calibrated is beneficially more reliable, and is beneficially used to estimate the probabilities of the players 104 being within one or more corresponding spatial zones of the spatial playing region 102 at any given time. Details of how these probabilities are estimated have been provided in conjunction with FIGS. 5A, 5B, 5C and 5D.

In an example, the position measurements may be collected for a dense grid defined on the spatial playing region 102. In another example, the position measurements may be collected sparsely for certain points, such as the line crossings and the corners on the spatial playing region 102.

FIG. 4 is an illustration of an example of position measurements collected sparsely on the spatial playing region 102, in accordance with an embodiment of the present disclosure. In FIG. 4, a scale 402 represents a coordinate system used to calibrate the position-measurement data on the spatial playing region 102. An origin (0,0) of this coordinate system is at a centre of the spatial playing region 102, namely, a centre of a centre circle of the basketball pitch.

With reference to FIG. 4, points on a line 404 are prone to larger measurement-biased errors relative to points on a line 406. This may have resulted from reflections of signals from one or more walls or other structures located in a proximity of the line 404 on the spatial playing region 102.

When the monitoring arrangement 202 generates position-measurement data corresponding to a particular point on the spatial playing region 102, the monitoring arrangement 202 optionally corrects measurement-biased errors corresponding to that particular point. If the measurement-biased errors for that particular point are not known, the monitoring arrangement 202 optionally uses interpolation of three or more known points that are located in a proximity of that particular point.

FIG. 4 is merely an example, which should not unduly limit the scope of the claims herein. A person skilled in the art will recognize many variations, alternatives, and modifications of embodiments of the present disclosure.

FIGS. 5A, 5B, 5C and 5D are illustrations of an example implementation of a particle filter employed by the data merging arrangement 206, in accordance with an embodiment of the present disclosure. For illustration purposes only, the particle filter has been implemented for a single player. The particle filter can be implemented for each of the players 104 in a similar manner.

FIG. 5A shows a probability distribution 502 of possible spatial positions of the player after time evolution, for example, from the time ‘t−1’ to the time ‘t’. The probability distribution 502 is beneficially determined based on the model employed by the data merging arrangement 206. Additionally, utilization of time evolution limits search space, and therefore, significantly reduces computations.

With reference to FIG. 5A, a dot 504 represents an actual spatial position of the player at the time ‘t−1’.

FIG. 5B shows a probability distribution 506 corresponding to the position-measurement data generated by the monitoring arrangement 202 at the time ‘t’.

FIG. 5C shows a probability distribution 508 corresponding to the position-measurement data generated by the camera arrangement 204 at the time ‘t’.

It is evident that the probability distribution 508 is multi-modal, due to an anonymous nature of the position-measurement data generated by the camera arrangement 204. Such multi-modal distributions are often obtained, when multiple players are spatially positioned in a proximity of each other. However, such multi-modal distributions do not lead to inaccurate results, as the output information is obtained by merging the probability distributions 502, 506 and 508 together.

For clarification in FIG. 5C is shown the camera arrangement 204 with Z-axis and X-axis relative to the camera arrangement 204. The Z-axis refers to distance away from camera in the direction of the camera view. X-axis refers to position of objects in relation to the camera view in left-right direction. (Additionally Y-axis could be added to refer position of the objects in up-down direction is respect to the camera view). Further the probability distribution 508 form factor is oval indicating that the camera arrangement 204 can typically used to provide more precise position measurement data in relation to X-axis than to Z-axis. In practice position precision from camera arrangement might be less accurate in relation to monitoring arrangement 202 in certain directions (such as Z-axis direction) but more accurate in relation to other direction (such as X-axis or Y-axis direction).

FIG. 5D shows a probability distribution 510 obtained by merging the probability distributions 506 and 508 together.

With reference to FIG. 5D, a dot 512 represents an accurate spatial position of the player at the time ‘t’. The dot 512 is obtained by merging the probability distributions 502, 506 and 508 together.

FIGS. 5A, 5B, 5C and 5D are merely examples, which should not unduly limit the scope of the claims herein. A person skilled in the art will recognize many variations, alternatives, and modifications of embodiments of the present disclosure.

It is to be noted here that the probability distributions 502, 506, 508 and 510 can be shown in any suitable coordinate system, such as the coordinate system represented by the scale 402 in FIG. 4, and/or the coordinate system of the video frames captured by the camera arrangement 204.

In some examples, the probability distributions 502 and 506 can be drawn in the coordinate system represented by the scale 402 first. Thereafter, the probability distributions 502 and 506 can be weighted and combined together to produce a resulting probability distribution, which can be projected onto the coordinate system of the video frames. Subsequently, the resulting probability distribution and the probability distribution 508 can be weighted and combined together to obtain a final probability distribution.

In some examples, a Kalman filter or an extended Kalman filter or an unscented Kalman filter (hereinafter collectively referred to as Kalman filters) can be employed, instead of the particle filter. However, these Kalman filters require probability distributions to be uni-modal, namely, Gaussian. Therefore, the Kalman filters cannot be used with multi-modal distributions, such as the probability distribution 508 shown in FIG. 5C.

Moreover, the particle filter can be used advantageously for non-parametric and multi-modal distributions with non-linear measurements, as illustrated in FIGS. 5A, 5B, 5C and 5D.

As the player exhibits Markov property, a probability distribution of a state of the player may be estimated recursively by using a Bayesian recursion equation (1) and a Chapman-Kolmogorov equation (2) as illustrated below:

$$\begin{matrix}Pr ( wt \vert x 1 … t ) = \frac{Pr ( xt \vert wt ) Pr ( wt \vert x 1 … t - 1 ) }{\int Pr ( xt \vert wt ) Pr ( wt \vert x 1 … t - 1 ) d wt} & ( 1 ) \\ Pr ( wt \vert x 1 … t - 1 ) = \int Pr ( wt \vert wt - 1 ) Pr ( wt - 1 \vert x 1 … t - 1 ) d wt - 1 & ( 2 )\end{matrix}$$

where ‘wₜ’ represents the state of the player at the time ‘t’, and
‘x_{1 . . . t}’ represents measurements of a state variable, namely, spatial position of the player, taken till the time ‘t’.

Additionally, the state of the player ‘wₜ’ may be represented as:

$$( \begin{matrix}xt \\ yt \\ \dot{x} t \\ \dot{y} t\end{matrix} )$$

where ‘xₜ’ and ‘yₜ’ represent position coordinates of the player, and
‘\dot{x}t’ and ‘\dot{y}t’ represent velocity of the player.

Moreover, the particle filter optionally approximates the probability distribution by using an equation (3) that uses weighted particles as illustrated below:

$$Pr ( wt - 1 \vert x 1 … t - 1 ) = {\sum }_{i} ai ( [ wt - 1 - {\hat{w}}_{τ - 1}^{[ i ]} ] \qquad ( 3 )$$

where ‘aᵢ’ represents weights that sum to unity.

Approximating the probability distribution significantly reduces unnecessary computations, as the approximated probability distribution identifies one or more spatial zones within which the player is most likely to be found. Therefore, computation of full probability distributions may not be required.

Equations (1), (2) and (3) are merely examples, which should not unduly limit the scope of the claims herein. A person skilled in the art will recognize many variations, alternatives, and modifications of embodiments of the present disclosure.

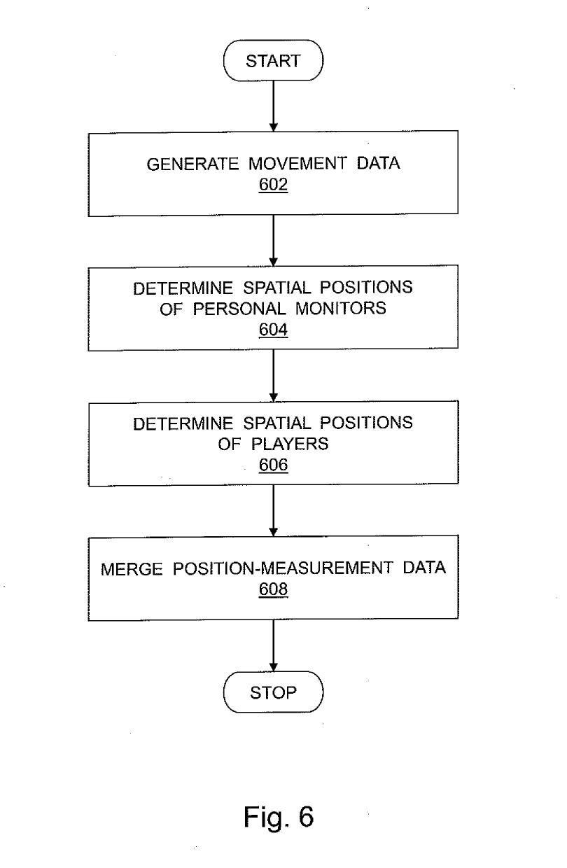

FIG. 6 is an illustration of steps of a method of employing the sports apparatus 200 for monitoring the spatial positions of the players 104 within the spatial playing region 102, in accordance with an embodiment of the present disclosure. The method is depicted as a collection of steps in a logical flow diagram, which represents a sequence of steps that can be implemented in hardware, software, or a combination thereof.

At a step 602, the personal monitors 106 generate their corresponding movement data, and communicate the movement data to the monitoring arrangement 202, as described earlier.

At a step 604, the monitoring arrangement 202 determines the spatial positions of the personal monitors 106 within the spatial playing region 102, and generates corresponding position-measurement data, as described earlier.

The step 604 optionally includes a sub-step at which the monitoring arrangement 202 calibrates the position-measurement data, as described earlier.

At a step 606, the camera arrangement 204 determines the spatial positions of the players 104 when they move within the spatial playing region 102, and generates corresponding position-measurement data, as described earlier.

The step 606 optionally includes a sub-step at which the camera arrangement 204 calibrates the cameras employed at the step 606, as described earlier.

Beneficially, the steps 602, 604 and 606 may be performed simultaneously.

The method optionally includes a step at which the data merging arrangement 206 is arranged to employ the model for the players 104, as described earlier.

Next, at a step 608, the data merging arrangement 206 merges the position-measurement data generated at the steps 604 and 606, to provide the output information indicative of accurate spatial positions of the players 104 within the spatial playing region 102.

The step 608 employs at least one particle filter, as described in conjunction with FIGS. 5A, 5B, 5C and 5D.

Beneficially, the step 608 can be performed separately for each of the players 104 using parallel computing.

The steps 602, 604, 606 and 608 can be beneficially performed in substantially real-time. This enables the sports apparatus 200 to function in substantially real-time, with the measurement-update rate of at least 10 samples per second.

The steps 602 to 608 are only illustrative and other alternatives can also be provided where one or more steps are added, one or more steps are removed, or one or more steps are provided in a different sequence without departing from the scope of the claims herein.

Embodiments of the present disclosure provide a computer program or software product recorded on non-transient machine-readable data storage media, wherein the computer program product is executable upon computing hardware or processor of the sports apparatus 200 for implementing the method as generally described herein and in conjunction with FIG. 6. The computing hardware is generally configured to execute machine readable instructions of the computer program product. The computing hardware can comprise at least one memory device and at least one processor or processing device,

Embodiments of the present disclosure are susceptible to being used for various purposes, including, though not limited to, enabling merging of position-measurement data originating from heterogeneous sources to provide accurate spatial positions of players within a spatial playing region in substantially real-time, without a need to compute full probability distributions over a whole of the spatial playing region; and enabling graphical visualization of the players on top of video frames for streaming to sports viewers and coaches substantially in real-time.

Modifications to embodiments of the present disclosure described in the foregoing are possible without departing from the scope of the present disclosure as defined by the accompanying claims. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

We claim:

1. A sports apparatus for monitoring one or more spatial positions of one or more players within a spatial playing region, wherein the sports apparatus includes:
one or more personal monitors that are carried by the one or more players when moving within the spatial playing region;
a monitoring arrangement coupled in communication with the one or more personal monitors for determining one or more spatial positions of the one or more personal monitors within the spatial playing region;
a camera arrangement for capturing views of at least a portion of the spatial playing region for determining spatial positions of the one or more players when moving within the spatial playing region; and
a data merging arrangement for merging position-measurement data generated by the monitoring arrangement and the camera arrangement to provide output information indicative of the one or more spatial positions of the one or more players within the spatial playing region.

2. The sports apparatus as claimed in claim 1, wherein the monitoring arrangement is configured to employ wireless communication for sending and/or receiving signals to and/or from the one or more personal monitors, and to employ, for position measurement within the spatial playing region, at least one of: triangulation measurement, trilateration measurement, Time-of-Flight (ToF) measurement, Received Signal Strength Indicator (RSSI) measurement, Global Positioning System (GPS) measurement.

3. The sports apparatus as claimed in claim 1, wherein the data merging arrangement is configured to operate in substantially real-time and to receive the position-measurement data generated by the monitoring arrangement and the camera arrangement in substantially real-time.

4. The sports apparatus as claimed in claim 1, wherein the data merging arrangement is configured to employ a model for the one or more players based upon one or more probabilities of the one or more players being within one or more corresponding spatial zones of the spatial playing region at any given time, wherein the one or more spatial zones are moved within the model corresponding to one or more rates and/or one or more directions of spatial movements of the one or more players within the spatial playing region.

5. The sports apparatus as claimed in claim 1, wherein the data merging arrangement is configured to employ at least one particle filter for merging the position-measurement data generated by the monitoring arrangement and the camera arrangement to provide the output information indicative of the one or more spatial positions of the one or more players within the spatial playing region.

6. The sports apparatus as claimed in claim 1, wherein the monitoring arrangement in combination with the one or more personal monitors is configured to enable the data merging arrangement to identify the one or more spatial positions of the one or more personal monitors and corresponding unique identities of the one or more personal monitors, whereby the corresponding unique identities identify the one or more players carrying the one or more personal monitors; and the camera arrangement is configured to enable the data merging arrangement to identify the spatial positions of the one or more players but not their corresponding unique identities, wherein the monitoring arrangement provides less accurate measurements of spatial positions relative to the camera arrangement.

7. The sports apparatus as claimed in claim 1, wherein the sports apparatus is configured to function in substantially real-time, with a measurement-update rate of at least 10 samples per second.

8. The sports apparatus as claimed in claim 1, wherein the camera arrangement is configured to employ at least one of: one or more Pan-Tilt-Zoom (PTZ) cameras following movement of the one or more players, one or more stationary cameras imaging substantially a whole of the spatial playing region.

9. The sports apparatus as claimed in claim 1, wherein the sports apparatus is arranged to be used in association with at least one of: a basketball pitch, a handball pitch, a football pitch, an American football pitch, a hockey pitch, an ice hockey pitch, a tennis pitch, a cricket pitch, a cricket field, a volleyball pitch, a baseball field, a polo field, a golf course.

10. A method of employing a sports apparatus for monitoring one or more spatial positions of one or more players within a spatial playing region, wherein the sports apparatus includes one or more personal monitors that are carried by the one or more players when moving within the spatial playing region, and a monitoring arrangement coupled in communication with the one or more personal monitors for determining one or more spatial positions of the one or more personal monitors within the spatial playing region, wherein the method includes:
using a camera arrangement of the sports apparatus for capturing views of at least a portion of the spatial playing region for determining spatial positions of the one or more players when moving within the spatial playing region; and
using a data merging arrangement of the sports apparatus for merging position-measurement data generated by the monitoring arrangement and the camera arrangement to provide output information indicative of the one or more spatial positions of the one or more players within the spatial playing region.

11. The method as claimed in claim 10, wherein the method includes:
arranging for the monitoring arrangement to employ wireless communication for sending and/or receiving signals to and/or from the one or more personal monitors; and
arranging for the monitoring arrangement to employ, for position measurement within the spatial playing region, at least one of: triangulation measurement, trilateration measurement, Time-of-Flight (ToF) measurement, Received Signal Strength Indicator (RSSI) measurement, Global Positioning System (GPS) measurement.

12. The method as claimed in claim 10, wherein the method includes arranging for the data merging arrangement to operate in substantially real-time and to receive the position-measurement data generated by the monitoring arrangement and the camera arrangement in substantially real-time.

13. The method as claimed in claim 10, wherein the method includes arranging for the data merging arrangement to employ a model for the one or more players based upon one or more probabilities of the one or more players being within one or more corresponding spatial zones of the spatial playing region at any given time, wherein the one or more spatial zones are moved within the model corresponding to one or more rates and/or one or more directions of spatial movements of the one or more players within the spatial playing region.

14. The method as claimed in claim 10, wherein the method includes arranging for the data merging arrangement to employ at least one particle filter for merging the position-measurement data generated by the monitoring arrangement and the camera arrangement to provide the output information indicative of the one or more spatial positions of the one or more players within the spatial playing region.

15. The method as claimed in claim 10, wherein the method includes:
using the monitoring arrangement in combination with the one or more personal monitors to enable the data merging arrangement to identify the one or more spatial positions of the one or more personal monitors and corresponding unique identities of the one or more personal monitors, whereby the corresponding unique identities identify the one or more players carrying the one or more personal monitors; and
using the camera arrangement to enable the data merging arrangement to identify the spatial positions of the one or more players but not their corresponding unique identities,
wherein the monitoring arrangement provides less accurate measurements of spatial positions relative to the camera arrangement.

16. The method as claimed in claim 10, wherein the method includes arranging for the sports apparatus to function in substantially real-time, with a measurement-update rate of at least 10 samples per second.

17. The method as claimed in claim 10, wherein the method includes arranging for the camera arrangement to employ at least one of: one or more Pan-Tilt-Zoom (PTZ) cameras following movement of the one or more players, one or more stationary cameras imaging substantially a whole of the spatial playing region.

18. The method as claimed in claim 10, wherein the method includes using the sports apparatus in association with at least one of: a basketball pitch, a handball pitch, a football pitch, an American football pitch, a hockey pitch, an ice hockey pitch, a tennis pitch, a cricket pitch, a cricket field, a volleyball pitch, a baseball field, a polo field, a golf course.

19. A computer program product recorded on non-transient machine-readable data storage media, wherein the computer program product is executable upon a computing hardware for implementing the method as claimed in claim 10.
